(19) United States
(12) Patent Application Publication
(10) Pub. No.: US 2006/0046988 A1
(43) Pub. Date: Mar. 2, 2006

(54) Methoprene formulations for the control of tick infestations

(76) Inventors: Albert Boeckh, Cumming, GA (US); Mark D. Soll, Alpharetta, GA (US); Luiz Gustavo Cramer, Cumming, GA (US)

Correspondence Address: JUDY JARECKI-BLACK; PH.D., J.D., 3239 SATELLITE BLVD. 3RD FLOOR, DULUTH, GA, 30096, US

(21) Appl. No.: 10/929,176

(22) Filed: Aug. 30, 2004

(51) Int. Cl. A01N 43/40; A01N 53/00; A01N 43/58; A01N 43/60

(52) U.S. Cl. 514/248; 514/468; 514/531; 514/345

(57) ABSTRACT

The present invention relates to a composition and process, in particular for controlling ticks on animals, characterized in that the composition includes, on the one hand, at least one compound of IGR (insect growth regulator) type, in doses and proportions which are parasiticidally effective on ticks, in a fluid vehicle which is acceptable for the animal and convenient for local application to the skin, preferably localized over a small surface area.

### FIELD OF THE INVENTION

This invention relates to formulations comprising methoprene and methods of use for arresting the development of certain arthropod ectoparasites, thereby preventing or interrupting the transmission of the ectoparasites from one host to another. This invention further relates to methods of topically administering such compositions to animals, in particular to mammals and birds.

### BACKGROUND OF THE INVENTION

The approximately 850 described species of ticks belonging to the class of Arachnida, (order Acarina) are exclusively blood-sucking in all feeding stages. Ticks transmit a variety of infectious agents to both man and animals. For example, tick transmission is implicated in Lyme Disease, Rocky Mountain Spotted Fever, and typhus among other diseases. In addition to transmitting infectious agents, ticks can harm their hosts directly. For example, tick bites can induce toxicosis (eg. sweating sickness and tick paralysis caused by salivary fluids and toxins); produce skin wounds susceptible to secondary bacterial infections and screwworm infestations; and is implicated in anemia.

Boophilus microplus is a one-host tick distributed throughout much of the world. In Australia, B. microplus is the most serious ectoparasite of cattle. This tick transmits several diseases known collectively as ‘tick fever’, including babesiosis (caused by the apicomplexans Babesia bovis and B. bigemina) and anaplasmosis (caused by the rickettsia Anaplasma marginale). Members of this tick genus have also been implicated as vectors for several viral hemorrhagic fevers (e.g., Crimean-Congo hemorrhagic fever). Rhipicephalus sanguineus, the kennel tick or brown dog tick, is a common parasite of the domestic dogs and is implicated as a vector of Babesia canis, Ehrlichia canis, Rickettsia rhipicephali, Rickettsia conorii, Crimean-Congo hemorrhagic fever virus, and Thogoto virus.

Various compositions are known in the art for use in the control of arthropod ectoparasites such as ticks and mites. For example, WO-A-87/3781, EP-A-295,117 and EP-A-500,209 describe a class of insecticides which are N-phenyl-pyrazole derivatives. These compounds have activity against a very large number of ectoparasites, including B. microplus, in fields as varied as agriculture, public health and veterinary medicine. The compositions may be administered via various routes including through oral, parenteral, percutaneous and topical administration.

Other compositions useful in the control of ectoparasites include insect growth regulators (IGRs) which are widely used to prevent development of immature stages of fleas (order Aphaniptera). Compounds with an ovicidal and/or larvicidal effect on the immature stages of various arthropod ectoparasites are already known, for example, as disclosed in U.S. Pat. Nos. 5,439,924, 3,748,356, 3,818,047, 4,225,598, 4,798,837 and 4,751,225, as well as in EP 179,022 and U.K. 2,140,010. French Patent No. A-2,713,889 discloses an IGR combination comprising a juvenile hormone activity and chitin synthesis inhibitors, and at least one of three N-arylpyrazole compounds, in particular fipronil, suitable for controlling various ectoparasites.

Methoprene, fenoxycarb, and pyriproxyfen are juvenile hormone analogs known to mimic the activity of insect juvenile hormones. When these compounds are applied directly to flea larvae or into their environment, they are absorbed by the immature forms and act like natural insect juvenile hormone to regulate the gene expression during the development of larval morphologic characteristics. Larvae are prevented from completing metamorphosis and subsequently die. In addition, these compounds also have ovicidal and embryocidal activity when applied to adult female fleas. While these compounds have been developed as control agents for fleas, they can also be active against a wide range of other arthropod species. However, their use outdoors is preferably limited to heavily infested habitats to avoid undesired side-effects on beneficial insect species.

Lufenuron, a benzoylphenyl urea, on the other hand, inhibits the formation of chitin which is an essential component of the flea exoskeleton. It acts systemically to prevent feeding fleas from producing viable eggs or larvae. Other insect development inhibitors, such as diflubenzuron and cyromazine, also have considerable activity against developing fleas.

Other compositions useful against ectoparasites include those disclosed in U.S. Pat. No. 6,492,419 to Schepherd comprising an aqueous-based wash formulation containing a water insoluble IGR and a blend of surfactant and wetting agents for controlling sheep lice. U.S. Pat. No. 5,942,525 to Pennington et al. discloses a method for treating animals to remove ectoparasites, including fleas and ticks, comprising applying a localized application to the skin of a composition containing a growth regulating effective amount of pyriproxyfen in combination with an insecticide.

Although IGRs are known with efficacy against fleas, only some are efficacious against ticks and, typically, requires the use of high concentrations of the IGR. Such high concentrations are associated with a significant hazard to the animal to be treated and its environment. Compositions that are effective against non-insect arthropod ectoparasites, such as ticks, which are efficacious at reduced concentrations would therefore be desirable.

### SUMMARY OF THE INVENTION

The present invention provides novel compositions and formulations thereof that are unexpectedly effective against ticks and other arachnid ectoparasites. In particular, a composition according to the present invention comprises an insect growth regulators (IGR), or salt thereof, and in particular a methoprene These compounds and formulations are effective for arresting or inhibiting the development of immature stages of arachnid ectoparasites. The present invention further provides various methods of topically administering such compositions to the skin or hair (including feathers) of animals, in particular of mammals and birds, for reducing an established infestation of ectoparasites and for reducing the rate of transmission of such ectoparasites from one host to another. The present invention, therefore, provides topical skin solutions that contain an insect growth regulating product or products and is intended to be applied topically to mammals, such as cattle, sheep, pigs, horses, dogs, cats, and the like, as well as to birds.

It is an object of the present invention to provide a method of preventing a female tick from laying eggs and preventing the development of immature stages of certain arachnid ectoparasites comprising administering or applying a topical formulation to a host that comprises at least one insect growth regulating compound (IGR), preferably methoprene, that is not highly concentrated and which demonstrates a high level of efficacy against the development of immature stages of some arachnid ectoparasites.

Another object of this invention is to particularly provide an effective means for controlling mites and ticks, most particularly Boophilus microplus in cattle, sheep, and horses, and Rhipicephalus spp. in dogs and cats, under the conditions in which these animals are reared.

Applicants have found that it is possible to effectively control arthropod ectoparasites of mammals and birds, particularly those from the class of arachnida and, more particularly, ticks such as, for example, Boophilus microplus and Rhipicephalus spp. using a topical formulation made according to the present invention. A particular aim of the present invention is thus to provide a method which is entirely effective against mites and ticks on animals, including Boophilus microplus and Rhipicephalus spp., comprising the application or administration to an animal of a topical formulation comprising at least one IGR compound at a low to moderate concentration. Compositions and formulations made in accordance with the present invention are entirely suitable for controlling ectoparasites, such as ticks, on animals under the conditions in which these animals are reared. A composition provided in accordance with the present invention has a long period of efficacy equal to, or exceeding, one to two months after treatment. The formulation of the present invention is easy to use and entirely compatible with use on herds or flocks containing a large number of animals.

The formulation of the invention is particularly suitable for controlling ticks and similar ectoparasites on animals subjected to extensive pasture rearing and for protecting such animals during the period of rounding up and finishing, namely the final period of rearing in which a large number of animals are herded into a small enclosure over an average period of two months preceding slaughter.

The present invention further provides methods for the control or elimination of external parasites from animals by preventing the development of the immature stages of external arachnid parasites, comprising topically applying to an animal at least monthly, an effective amount of a spray, spot-on, pour-on or wash formulation comprising an IGR, especially methoprene, at a low or moderate concentration.

One aspect of the invention, therefore, includes embodiments of a method for preventing ticks from laying eggs and preventing or arresting the development of immature stages of an arthropod ectoparasite, in particular an arachnid such as tick or mite, on an animal host which comprises applying or administering a topical formulation to the host, wherein the formulation comprises an amount of an insect growth regulator (IGR) effective in inhibiting the maturation of an arthropod ectoparasite on the surface of an animal, a pharmaceutically acceptable liquid carrier or vehicle and, optionally, a crystallizing inhibitor.

It is noted that in this disclosure and particularly in the claims, terms such as “comprises”, “comprised”, “comprising” and the like can have the meaning attributed to such terms in U.S. Patent law; e.g., they can mean “includes”, “included”, “including”, and the like; and that terms such as “consisting essentially of” and “consists essentially of” have the meaning ascribed to them by U.S. Patent law, e.g., they allow for elements not explicitly recited, but exclude elements that are found in the prior art or that affect a basic or novel characteristic of the invention.

These and other embodiments are disclosed in, or are obvious from and encompassed by, the Detailed Description below.

### DESCRIPTION OF THE FIGURES

FIG. 1 illustrates the percentage of hatched eggs for Replicates A, B, and C for each treatment group.

FIG. 2 illustrates average egg mass weight per tick for the three replicates with each treatment group.

### DETAILED DESCRIPTION OF THE INVENTION

Other objects, features and aspects of the present invention are disclosed in, or are obvious from, the following Detailed Description. It is to be understood by one of ordinary skill in the art that the present discussion is a description of exemplary embodiments only and is not intended as limiting the broader aspects of the present invention, which broader aspects are embodied in the exemplary construction. In fact, it will be apparent to those skilled in the art that various modifications and variations can be made in the present invention without departing from the scope or spirit of the invention. For instance, features illustrated or described as part of one embodiment can be used in another embodiment to yield a still further embodiment. It is intended that the present invention cover such modifications and variations as come within the scope of the appended claims and their equivalents. The contents of all references, published patents, and patents cited throughout the present application are hereby incorporated by reference in their entirety.

This invention provides novel compositions, and formulations thereof, comprising an insect growth regulator, in particular a methoprene, the compounds and formulations being effective for controlling or inhibiting the egg laying and/or arresting the development of immature stages of arthropod ectoparasites, most especially arachnids such as ticks and mites. Further, this invention provides various methods of topically administering such compositions to the skin, hair or feathers of animals, in particular to mammals and birds, for reducing an established infestation and for inhibiting the transmission of such ectoparasites from one host to another. The present invention, therefore, provides wash or topical skin solutions, such as a pour-on or spot-on formulation containing an insect growth regulating product or products and is intended to be applied topically to mammals, such as cattle, sheep, pigs, horses, dogs, cats, and the like, and to birds including poultry, such as turkeys and chickens.

For convenience, certain terms employed in the Specification, Examples, and appended Claims are collected here.

The term “insect growth regulator” (IGR) as used herein refers to a compound or combination of compounds that reduce or inhibit the maturation or development of arthropod larvae to the mature adult form. IGRs may be juvenile insect hormone analogs, chitin synthesis inhibitors, or any combination thereof.

The terms “pharmaceutically acceptable liquid carrier” or “pharmaceutically acceptable vehicle” refers to a liquid carrier or vehicle comprising a solvent that may be topically applied to the skin or hair of a mammal or bird and which does not generate an adverse reaction that is harmful to the health or survival of the recipient.

The term “pour-on skin solution” or “spot-on skin solution” as used herein refers to a solution intended to be applied topically and locally on the animal. A pour-on formulation is typically applied to the animal's back at several points or along the line of the back, and applied in low volume such as 5 to 20 ml per 100 kg, preferably about 10 ml per 100 kg, with a total volume of from 10 to 150 ml per animal. A spot-on formulation is also applied topically, but is typically applied to a smaller area on the animal than a pour-on product. For example, spot-on and pour-on formulations having parasiticidal activity are disclosed in U.S. Pat. No. 6,426,333, to Huet et al., and U.S. Pat. No. 6,395,765 to Etchegaray.

The term “crystallizing inhibitor” or “crystallization inhibitor” as used herein refers to a compound or combination of compounds that inhibit or prevent the crystallization of a compound from a carrier.

The term “acid” contemplates all pharmaceutically or veterinary acceptable inorganic or organic acids. Inorganic acids include mineral acids such as hydrohalic acids, such as hydrobromic and hydrochloric acids, sulfuric acids, phosphoric acids and nitric acids. Organic acids include all pharmaceutically or veterinary-acceptable aliphatic, alicyclic and aromatic carboxylic acids, dicarboxylic acids, tricarboxylic acids and fatty acids. Preferred acids are straight chain or branched, saturated or unsaturated C₁-C₂₀ aliphatic carboxylic acids, which are optionally substituted by halogen or by hydroxyl groups, or C₆-C₁₂ aromatic carboxylic acids. Examples of such acids are carbonic acid, formic acid, fumaric acid, acetic acid, propionic acid, isopropionic acid, valeric acid, α-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tataric acid and maleic acid. An example of a tricarboxylic acid is citric acid. Fatty acids include all pharmaceutically or veterinary-acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenyisteric acid. Other acids include gluconic acid, glycoheptonic acid and lactobionic acid.

The term “base” contemplates all pharmaceutically or veterinary acceptable inorganic or organic bases. Such bases include, for example, the alkali metal and alkaline earth metal salts, such as the lithium, sodium, potassium, magnesium or calcium salts. Organic bases include the common hydrocarbyl and heterocyclic amine salts, which include, for example, the morpholine and piperidine salts.

The compositions according to the present invention, in particular those for spot-on or topical application, provide effective prolonged treatment against ticks on animals, and in particular small mammals such as cats and dogs. It is believed likely that a compound, such as (S)-methoprene, dissolves in the sebum so as to cover the entire animal and becomes concentrated in the sebaceous glands, from which it is gradually released over a very long period, is a plausible explanation of this long-lasting efficacy for these compositions.

This invention is based on the novel observation that low concentrations of the IGR compounds such as (S)-methoprene, have activity directed against the development of eggs and/or of the maturation of the juvenile forms of ticks, including Boophilus microplus, and Rhipicephalus sp. The solutions according to the invention inhibit adult tick species such as Boophilus microplus and Rhipicephalus spp from laying eggs as well as the development of the next generation of ticks, thereby reducing the number of parasites that develop and are available to infest new hosts.

It is understood that the application of the formulations according to the invention may be extended to the treatment of other ectoparasites, and even endoparasites, besides ticks for which the composition proves to have real utility capable of being obtained practically, according to the criteria of the veterinary art. Where appropriate, the composition according to the invention may also comprise at least one insecticide such as imidacloprid. It also may be preferable to use controlled-release formulations. This invention also provides for a method for cleaning the coats and the skin of animals by removal of the parasites and of their waste and excreta. The animals treated thus exhibit a coat which is more pleasing to the eye, more pleasant to the touch, and may present fewer harmful allergens to animals or humans.

Examples of arthropod ectoparasites that may be targeted by the methods of the present invention include, but are not limited to, the ticks Rhipicephalus sanguineus, Dermacentor variabilis, D. reticulatus, Amblyomma americanum, A. hebreum, A. cajennense, Ixodes scapularis, I. ricinus, I. dammini and Boophilus microplus and the like; mites such as house mites, ear mites, dust mites, Trombiculid mites, and Straw Itch mites; fleas including Ctenocephalides felis, C. canis and the like; myiases such as Dermatobia hominis (known as Berne in Brazil) and Cochlyomia hominivorax (greenbottle); sheep myiases such as Lucilia sericata, Lucilia cuprina (known as blowfly strike in Australia, New Zealand and South Africa) whose larva constitutes the animal parasite; flies proper whose adult constitutes the parasite, including Haematobia irritans (horn fly); lice such as Linognathus vitulorum, Felicola subrostratus, Damalinia bovis and Trichodectes canis; Sarcoptes scabiei; Psoroptes ovis; mosquitoes such as Aedes spp. and Culex spp. and the like.

One aspect provided by the present invention is a method for reducing or inhibiting the maturation of arachnid ectoparasites on the skin surface or the hair (or feathers) of an animal host. The present invention, therefore, provides a method for inhibiting the development of immature stages of certain ectoparasites, especially arachnids, more especially ticks and/or mites, on a host which comprises applying or administering a topical formulation to the host, the formulation comprising an effective amount of at least one IGR, wherein the concentration of the IGR is from about 1% to about 50% w/v, a pharmaceutically acceptable liquid carrier or vehicle, and optionally a crystallization inhibitor.

The compounds of the formulation of the present invention may be prepared according to one or other of the processes described in patent applications WO-A-87/3781, 93/6089, 94/21606 or European patent application EP-A-0,295,117, or any other process which falls within the competence of a specialist skilled in the art of chemical synthesis. For the chemical preparation of the products of the invention, a person skilled in the art is considered as having at his disposal, inter alia, all of the contents of “Chemical Abstracts” and the documents cited therein.

Spot-on formulations may be prepared by dissolving the active ingredients into a pharmaceutically or veterinary acceptable vehicle. Alternatively, the spot-on formulation can be prepared by encapsulation of the active ingredient to leave a residue of the therapeutic agent on the surface of the animal. These formulations will vary with regard to the weight of the therapeutic agent in the combination depending on the species of host animal to be treated, the severity and type of infection and the body weight of the host. The compounds may be administered continuously, particularly for prophylaxis, by known methods. Generally, a dose of from about 0.001 to about 100 mg per kg of body weight given as a single dose or in divided doses for a period of from 1 to 5 days will be satisfactory but, of course, there can be instances where higher or lower dosage ranges are indicated and such are within the scope of this invention. It is well within the routine skill of the practitioner to determine a particular dosing regimen for a specific host and parasite.

Preferably, a single formulation containing the IGR in a substantially liquid carrier and in a form which makes possible a single application, or an application repeated a small number of times, will be administered to the animal over a highly localized region of the animal, preferably between the two shoulders.

The composition for spot-on application may optionally comprise water, in particular in a proportion of from 0 to 30% v/v, in particular from 0 to 5% v/v. The composition for spot-on application may also comprise an antioxidant intended to inhibit air-oxidation. Antioxidants useful in the present invention include, but are not limited to, alpha tocopheral, ascorbic acid, ascrobyl palmitate, fumeric acid, malic acid, sodium ascorbate, sodium metabisulfate, n-propyl gallate, BHA (butylated hydroxy anisole), BHT (butylated hydroxy toluene) monothioglycerol, sodium thiosulphate and the like, or mixtures thereof. The antioxidants are generally added to the formulation in amounts of from about 0.01 to about 2.0%, based upon total weight of the formulation, with about 0.1 to about 1.0% being especially preferred.

In embodiments made in accordance with the present invention, the pharmaceutically acceptable liquid carrier or vehicle comprises a solvent which may have a dielectric constant of between 10 and 35, and preferably of between 20 and 30, the content of this solvent in the overall composition preferably representing the difference to make the composition up to 100%. An organic cosolvent having a boiling point of below 100° Celsius, preferably of below 80° Celsius, and having a dielectric constant of between 10 and 40, preferably of between 20 and 30 may also be included in the formulation. The cosolvent should be volatile, so as to serve in particular as a drying promoter, and is miscible with water and/or with the solvent. Cosolvent useful in the present invention include, but are not limited to, absolute ethanol, isopropanol, methanol or a combination thereof.

Solvents useful in the present invention may be selected from the group consisting of acetone, acetonitrile, benzyl alcohol, butyl diglycol, dimethylacetamide, dimethylformamide, dipropylene glycol n-butyl ether, ethanol, isopropanol, methanol, ethylene glycol monoethyl ether, ethylene glycol monomethyl ether, monomethylacetamide, dipropylene glycol monomethyl ether, liquid polyoxyethylene glycols, propylene glycol, 2-pyrrolidone, diethylene glycol monoethyl ether, ethylene glycol, and diethyl phthalate fatty acid esters and a crystallizing inhibitor is selected from the group consisting of: an anionic surfactant, a cationic surfactant, a non-ionic surfactant, an amine salt, an amphoteric surfactant or polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters, lecithin, sodium carboxymethylcellulose, and acrylic derivatives, and a mixture thereof. Plant oils such as soybean oil, groundnut oil, castor oil, corn oil, cotton oil, olive oil, grape seed oil, sunflower oil, etc.; mineral oils such as petrolatum, paraffin, silicone, etc.; aliphatic or cyclic hydrocarbons or alternatively, for example, medium-chain (C₈ to C₁₂ in particular) triglycerides are also contemplated as antioxidants in a formulation made according to the present invention.

The present invention also contemplates compositions or formulations having a crystallization inhibitor which can, in particular, be present in a proportion of about 1 to about 20% (w/v), preferably of about 5 to about 15%. The inhibitor preferably corresponds to the test in which 0.3 ml of a solution comprising 10% (w/v) of the compound of the present invention in the liquid carrier and 10% of the inhibitor are deposited on a glass slide at 20° Celsius and allowed to stand for 24 hours. The slide is then observed with the naked eye. Acceptable inhibitors are those whose addition provides for few or no crystals, and in particular less than 10 crystals, preferably 0 crystals.

Crystallization inhibitors suitable for use in the present invention include polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters; lecithin, sodium carboxymethylcellulose, acrylic derivatives such as methacrylates and the like, anionic surfactants such as alkaline stearates, in particular sodium, potassium or ammonium stearate; calcium stearate; triethanolamine stearate; sodium abietate; alkyl sulphates, in particular sodium lauryl sulphate and sodium cetyl sulphate; sodium dodecylbenzenesulphonate, sodium dioctylsulphosuccinate; fatty acids, in particular those derived from coconut oil, cationic surfactants such as water-soluble quaternary ammonium salts of formula N⁺ R′R″R′″R″″,Y⁻ in which the radicals R are optionally hydroxylated hydrocarbon radicals and Y⁻ is an anion of a strong acid such as the halide, sulphate and sulphonate anions; cetyltrimethylammonium bromide is among the cationic surfactants which can be used, amine salts of formula N⁺ R′R″R′″ in which the radicals R are optionally hydroxylated hydrocarbon radicals; octadecylamine hydrochloride is among the cationic surfactants which can be used, nonionic surfactants such as optionally polyoxyethylenated sorbitan esters, in particular polysorbate 80, polyoxyethylenated alkyl ethers; polyethylene glycol stearate, polyoxyethylenated derivatives of castor oil, polyglycerol esters, polyoxyethylenated fatty alcohols, polyoxyethylenated fatty acids, copolymers of ethylene oxide and propylene oxide, amphoteric surfactants such as substituted lauryl compounds of betaine, and any combination thereof. In one embodiment of the present invention, a crystallization inhibitor couple, namely the combination of a film-forming agent of polymeric type and a surfactant, will be used.

An emollient and/or spreading and/or film-forming agent may also be added to the inventive formulation, this agent being selected from, but not limited to, polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters; lecithin, polyoxypropylene 15 stearyl ether, sodium carboxymethylcellulose, silicone oils, polydiorganosiloxane oils, in particular polydimethylsiloxane (PDMS) oils, for example those containing silanol functionalities, or a 45V2 oil.

Additionally, the inventive formulations may contain other inert ingredients such as colorants, preservatives, stabilizers or surfactants. These compounds are well known in the formulation art. Preservatives, such as the parabens (methylparaben and/or propylparaben), are suitably used in the formulation in amounts ranging from about 0.01 to about 2.0%, with about 0.05 to about 1.0% being especially preferred. Other preservatives include benzalkonium chloride, benzethonium chloride, benzoic acid, benzyl alcohol, bronopol, butylparaben, cetrimide, chlorhexidine, chlorobutanol, chlorocresol, cresol, ethylparaben, imidurea, methylparaben, phenol, phenoxyethanol, phenylethyl alcohol, phenylmercuric acetate, phenylmercuric borate, phenylmercuric nitrate, potassium sorbate, sodium benzoate, sodium propionate, sorbic acid, thimerosal, propyl paraben, myristyl gama-picolinium chloride, paraben methyl, paraben propyl and quaternary ammonium compounds and the like.

Surfactants in amounts from about 0.001 to about 1%, based upon total weight may be added to help solubilize the active drug, to prevent crystallization, and to prevent phase separation. Anionic surfactants such as alkaline stearates, in particular sodium, potassium or ammonium stearates; calcium stearate, triethanolamine stearate; sodium abietate; alkyl sulphates, in particular sodium lauryl sulphate and sodium cetyl sulphate; sodium dodecylbenzenesulphonate, sodium dioctylsulphosuccinate; fatty acids, in particular those derived from coconut oil and cationic surfactants such as water-soluble quaternary ammonium salts of formula N⁺R′R″R′″R″″, Y⁻ in which the radicals R are optionally hydroxylated hydrocarbon radicals and Y⁻ is an anion of a strong acid such as the halide, sulphate and sulphonate anions; cetyltrimethylammonium bromide are among the surfactants which can be used in the formulations for use in the methods of the invention, Nonionic surfactants such as sorbitan esters, which are optionally polyoxyethylenated, in particular polysorbate 80, polyoxyethylenated alkyl ethers; polyoxypropylated fatty alcohols such as polyoxypropylene-styrol ether; polyethylene glycol stearate, polyoxyethylenated derivatives of castor oil, polyglycerol esters, polyoxyethylenated fatty alcohols, polyoxyethylenated fatty acids, copolymers of ethylene oxide and propylene oxide and amphoteric surfactants such as the substituted lauryl compounds of betaine or a mixture of at least two of these agents may be used from, for example, 0.1 to 10%, in particular from 0.25 to 5%, by volume.

Colorants may be added to the inventive formulations. Colorants contemplated by the present invention are those commonly known in the art. Specific colorants include, for example, dyes, an aluminum lake, caramel, colorant based upon iron oxide or a mixture of any of the foregoing. Especially preferred are organic dyes and titanium dioxide. Preferred ranges include from about 0.5% to about 25%.

The compositions for spot-on application according to the invention are usually prepared by simple mixing of the constituents as defined earlier; advantageously, to begin with, the active material is mixed in the main solvent and the other ingredients or adjuvants are then added. The volume applied may be from about 0.3 to 1 ml, preferably about 0.5 ml for cats, and from about 0.3 to 3 ml for dogs, according to the weight of the animal.

In a particularly preferred manner, the composition according to the invention may be in the form of a concentrated emulsion, suspension or solution for spot-on application to a small area of the animal's skin. In a clearly less preferred manner, forms of solution or suspension to be sprayed, forms of solution, suspension or emulsion to be poured or spread onto the animal (pour-on type solution) an oil, a cream, an ointment or any other fluid formulation for topical administration may be provided.

Administration of the inventive formulation may be intermittent in time and may be administered daily, weekly, biweekly, monthly, bimonthly, quarterly, or even for longer durations of time. The time period between treatments depends upon factors such as the parasite(s) being treated, particularly the infesting tick species, the degree of infestation, the type of animal, mammal or bird, and the environment where it resides. It is well within the skill level of the practitioner to determine a specific administration period for a particular situation. This invention contemplates a method for permanently combating an ectoparasite in an environment in which the animal is subjected to strong parasitic pressure where the administration is at a frequency far below a daily administration in this case. For example, it is preferable for the treatment according to the invention to be carried out monthly on mammals, such as on dogs and on cats.

The compositions according to the invention intended for animals, in particular mammals and birds, are generally applied by being deposited onto the skin (“spot-on” application); this is generally a localized application over a surface area of less than 10 cm², especially of between 5 and 10 cm². For pour-on applications, the composition is generally applied over the entire length of the back of the animal. Once deposited, the composition can diffuse throughout the animal's entire body, and then dry without crystallizing or modifying the appearance (in particular absence of any whitish deposit or dusty appearance) or the feel of the fur. The compositions for spot-on application according to the invention are particularly advantageous owing to their efficacy, their speed of action and the pleasant appearance of the animal's fur after application and drying.

In various embodiments of compositions or formulations made according to the present invention, the IGR, or mixture of IGRs, is selected from a group consisting of IGRs that mimic juvenile hormones such as, but not limited to, azadirachtin, agridyne, diofenolan, 4-chloro-2-(2-chloro-2-methylpropyl)-5-(6-iodo-3-pyridylmethoxy)pyridizin-3(2H)-one, fenoxycarb, hydroprene, kinoprene, methoprene, (S)-methoprene, pyriproxyfen, tetrahydroazadirachtin, and the like. The formulations useful in the present invention may further comprise at least one IGR that inhibits the synthesis of chitin such as, but not limited to cyromazine, 1-(2,6-difluorobenzoyl)-3-(2-fluoro-4-(1,1,2,2-tetrafluoroethoxy) phenylurea, chlorfluazuron, diflubenzuron, fluazuron, flucycloxuron flufenoxuron, hexaflumuron, 1-(2,6-difluorobenzoyl)-3-(2-fluoro-4-((trifluoromethyl) phenylurea, lufenuron, tebufenozide, triflumuron, teflubenzuron, and 1-(2,6-difluorobenzoyl)-3-(2-fluoro-4-trifluoromethyl) phenylurea and novaluron. Among the compounds of IGR type listed above, methoprenes such as S-methoprene, pyriproxyfens, novaluron, hydroprene, cyromazine, lufenuron and 1-(2,6-difluorobenzoyl)-3-(2-fluoro-4-(trifluoromethyl) phenylurea are preferred. Advantageously, the ready-to-use composition contains a dose of from 0.1 to 40 mg/kg of (S)-methoprene. In one embodiment of the present invention, a ready-to-use dosed formulation, in particular one for spot-on application, having 2 to 10 mg/kg of an IGR is contemplated.

Formulations made according to the present invention are extremely effective for long durations of time in the treatment of ectoparasites, such as ticks, of mammals and, in particular, of cattle, sheep, horses, pigs, dogs and cats. The inventive formulations also exhibit a degree of effectiveness against other arthropods such as fleas, lice, mosquitoes and flies.

The present invention also provides a method or process for the elimination of ectoparasites in animals, in particular Rhipicephalus sp. in companion animals and Boophilus microplus from cattle and sheep using a direct pour-on or spot-on skin solution so as to obtain long-lasting and broad-spectrum efficacy. The process consists in applying the solution to the skin and/or hair of the subject animal, the application preferably being repeated at least every two months. For livestock, the process consists of applying the solution to the animals in pastures and/or before they arrive in pasture or consists of in applying the solution to the animals before they arrive in the “feed lot”. For livestock, the efficacy of the formulations advantageously makes it possible to stop any application 1 to 3 months before slaughter.

Another aim of the formulations and methods of the present invention is to cleanse the skin and the hairs of the animals by eliminating the parasites which are present thereon. The result of this elimination is that the animals are no longer stressed by the parasites and their bites resulting in positive consequences, for example on the animal's growth.

One aspect of the invention, therefore, includes embodiments of a method for preventing the development of immature stages of an arthropod ectoparasite on an animal host or in the environment, which comprises applying or administering a topical formulation to the host, wherein the formulation comprises an amount of an insect growth regulator (IGR) effective in inhibiting the ovoposition and inhibiting the maturation of an arthropod ectoparasite on the surface of an animal, a pharmaceutically acceptable liquid carrier or vehicle, and optionally a crystallizing inhibitor.

In one embodiment of the method of the invention, the arthropod ectoparasite is an arachnid. In various embodiments of the method of the invention, the arachnid is selected from the group consisting of mites and ticks.

In one embodiment of the method of the invention, the tick is selected from the group consisting of: Rhipicephalus sanguineus, Rhipicephalus spp., Dermacentor variabilis, D. reticulatus, Amblyomma americanum, A. hebreum, A. cajennense, Ixodes scapularis, I. ricinus, I. dammini, Haemaphysalis sp. and Boophilus microplus.

In embodiments of the method of the invention, the formulation comprises an insect growth regulator (IGR) selected from the group consisting of methoprene, pyriproxyfen, lufenuron, azadirachtin, diofenolan, fenoxycarb, hydroprene, kinoprene, tetrahydroazadirachtin, and 4-chloro-2-(2-chloro-2-methylpropyl)-5-(6-iodo-3-pyridylmethoxy)pyridizin-3(2H)-one.

In various embodiments of the method of the invention, the pharmaceutically acceptable liquid carrier is selected from the group consisting of acetone, acetonitrile, benzyl alcohol, butyl diglycol, dimethylacetamide, dimethylformamide, dipropylene glycol n-butyl ether, ethanol, isopropanol, methanol, ethylene glycol monoethyl ether, ethylene glycol monomethyl ether, monomethylacetamide, dipropylene glycol monomethyl ether, liquid polyoxyethylene glycols, propylene glycol, 2-pyrrolidone, diethylene glycol monoethyl ether, ethylene glycol, and diethyl phthalate fatty acid esters.

In other embodiments of the method of the invention, the crystallization inhibitor is selected from the group consisting of an anionic surfactant, a cationic surfactant, a non-ionic surfactant, an amine salt, an amphoteric surfactant or polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters, lecithin, sodium carboxymethylcellulose, and acrylic derivatives, or a mixture of these crystallization inhibitors.

In one embodiment of the method of the invention, the concentration of the S-methoprene is from about 5% to about 25% w/v. In another embodiment of the method of the invention, the concentration of the IGR is from about 5% to about 25% w/v.

In other embodiments of the method of the invention, the formulation further comprises a pharmaceutically or veterinary acceptable film agent selected from the group consisting of a polyvinylpyrrolidone, a polyvinyl alcohol, a copolymer of vinyl acetate, a copolymer of vinyl pyrrolidone, a copolyvidone and mixtures thereof.

In one embodiment of the method of the invention, the topical formulation is a spot-on formulation.

In one embodiment of the method of the invention, the topical formulation is a spray.

In another embodiment of the method of the invention, the host animal is a mammal or a bird.

In yet another embodiment of the method of the invention, the mammal is a cow, a sheep, a horse, a pig, a cat or a dog.

In various embodiments of the method of the invention, the topical formulation is applied to the host as a powder, a shampoo, a soap, a wash, or a subcutaneous injectable.

In one embodiment of the method of the invention, the transmission of an arachnid ectoparasite from a first host to a second host is interrupted by preventing the development of an immature stage of the arachnid on the first host into a transmissible mature stage which comprises applying or administering the formulation to said first host.

In another embodiment, provided for separate application over time, a composition may be made in the form of a kit separately combining, in the same packaging, a composition containing an IGR compound, preferably (S)-methoprene, each of the composition including a vehicle which allows it to be applied onto the skin.

Preferably, each composition is provided for local spot-on application and, preferably, a container containing just the dose required is provided for each application. Thus, for example, a kit may contain, in a package, containers each containing a single dose of a composition comprising (S)-methoprene.

A better understanding of the present invention and of its many advantages will be had from the following examples,.given by way of illustration.

### EXAMPLE 1

### In Vitro Efficacy of (S)-Methoprene Against a Colonized Strain of the Brown Dog Tick Rhipicephalus saneuineus

The effect of (S)-methoprene on oviposition, egg mass weights, and egg eclosion was measured in adult females of a colonized strain of the brown dog tick, Rhipicephalus sanguineus. Approximately fifty R. sanguineus ticks were fed on twelve dogs each. Fully engorged females that dropped from the dogs over a period of two days were collected and combined into replicates. The following replicates were formed: Replicate A-50 ticks, Replicate B-40 ticks, and Replicate C-10 ticks. From each replicate A-C, 5 groups of equal numbers of ticks were formed, each group of ticks having similar combined body weights. Each of the 5 groups of ticks was randomly allocated to a treatment group.

The treatment groups were: Treatment I-Control: acetone/water (40%: 60%); Treatment 2-100 ppm (S)-methoprene dissolved in acetone/water (40:60); Treatment 3-1,000 ppm (S)-methoprene dissolved in acetone/water (40:60); Treatment 4-10,000 ppm (S)-methoprene dissolved in acetone/water (40:60); and Treatment 5-100,000 ppm (S)-methoprene dissolved in acetone/water (40:60). Each group of ticks was immersed in the appropriate test solution for two mins, after which they were removed, dried on a paper towel and placed in a clean container. All ticks in all treatment groups were kept in an environmental chamber maintained at 26-27° Celsius and 65-87% relative humidity. The number of ticks that laid eggs and total egg mass weights for each replicate of each treatment group was recorded 13 days after exposure to treatment. Additionally, an estimation of percentage of egg hatching for each replicate in each treatment group was recorded 48 days after exposure to treatment.

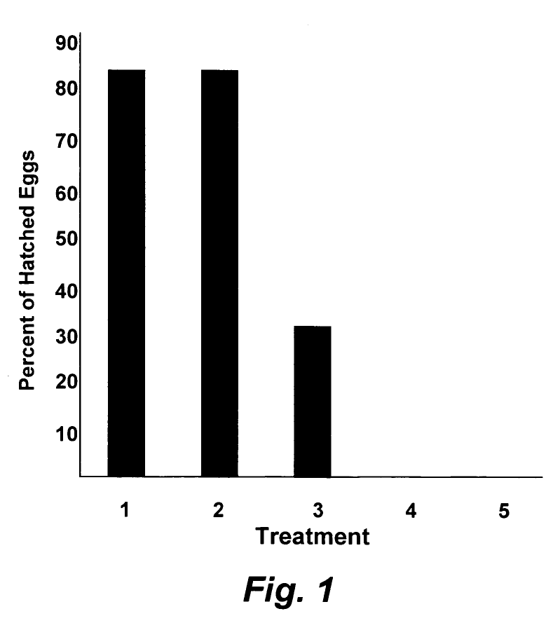

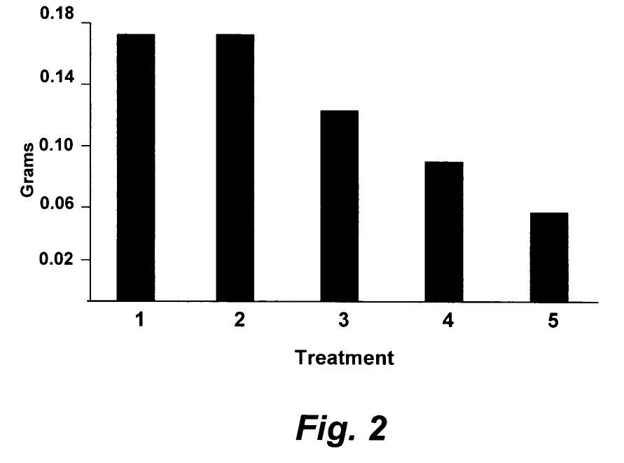

The number of ticks laying eggs, egg mass weights, percentage of eggs that hatched, and weight of viable eggs are provided in Table 1. Average percentage of hatched eggs for Replicates A, B, and C were combined is shown in FIG. 1. The percent reduction in egg mass and viable egg mass, as compared to the control group, are provided in Table 2 below. Egg mass weight per tick for the three replicates combined is shown in FIG. 2.

Reduction in total egg mass, egg mass per tick, viable egg mass and viable egg mass per tick were nonexistent in the control Group and in the 100 ppm Group. However, there was significant reduction in viable egg mass and viable egg mass per tick in the Groups treated with the higher concentrations of (S)-methoprene, reaching 100% for the 10,000 and 100,000 ppm concentrations. The results of immersing female Rhipicephalus sanguineus ticks in increasing concentrations of S-methoprene is illustrated in the following table:

TABLE 1

| | | Number of Ticks | | | | |
|---|---|---|---|---|---|---|
| S-Methoprene | | | Laying | Eggs | | |
| Concentration | Rep- | Treated | Eggs | Weight | Hatch | Viable |
| (ppm) | licate | (Day 0) | (Day 13) | (g) | (%) | (g) |
| 0 | A | 10 | 10 | 1.62 | 99 | 1.60 |
| 0 | B | 8 | 8 | 1.28 | 100 | 1.28 |
| 0 | C | 2 | 2 | 0.40 | 50 | 0.20 |
| 100 | A | 10 | 10 | 1.67 | 99 | 1.65 |
| 100 | B | 8 | 8 | 1.36 | 100 | 1.36 |
| 100 | C | 2 | 2 | 0.35 | 50 | 0.18 |
| 1,000 | A | 10 | 9 | 1.03 | 25 | 0.26 |
| 1,000 | B | 8 | 8 | 0.95 | 30 | 0.29 |
| 1,000 | C | 2 | 2 | 0.28 | 35 | 0.10 |
| 10,000 | A | 10 | 10 | 0.97 | 0 | 0 |
| 10,000 | B | 8 | 8 | 0.57 | 0 | 0 |
| 10,000 | C | 2 | 2 | 0.14 | 0 | 0 |
| 100,000 | A | 10 | 8 | 0.59 | 0 | 0 |
| 100,000 | B | 8 | 8 | 0.39 | 0 | 0 |
| 100,000 | C | 2 | 2 | 0.05 | 0 | 0 |

Table 2 illustrates the reduction of egg mass laid, and reduction of viable
ticks after exposure to increasing concentrations of (S)-methoprene.

| | Reduction in | | Reduction | Egg Mass | |
|---|---|---|---|---|---|
| | Ticks Laying | Total Egg | of Total | Per Tick | Egg Mass Per |
| Treatment | Eggs | Mass (g) | Egg Mass | (g) | Tick Reduction |
| 1 | | 3.30 | | 0.165 | |
| 2 | 0% | 3.38 | 0% | 0.169 | 0% |
| 3 | 5% | 2.26 | 32% | 0.119 | 28% |
| 4 | 0% | 1.68 | 49% | 0.084 | 49% |
| 5 | 10% | 1.03 | 69% | 0.057 | 65% |

| | Reduction in | | Reduction | Viable Egg | Reduction |
|---|---|---|---|---|---|
| | Ticks Laying | Total Viable | in Viable | Mass Per | Viable Egg |
| Treatment | Eggs | Egg Mass (g) | Egg Mass | Tick (g) | Mass Per Tick |
| 1 | | 3.08 | | 0.154 | |
| 2 | 0% | 3.19 | 0% | 0.160 | 0% |
| 3 | 5% | 0.65 | 79% | 0.034 | 78% |
| 4 | 0% | 0 | 100% | 0 | 100% |
| 5 | 10% | 0 | 100% | 0 | 100% |

Treatment 1: Control;
Treatment 2: 100 ppm (S)-methoprene;
Treatment 3: 1,000 ppm (S)-methoprene;
Treatment 4: 10,000 ppm (S)-methoprene;
Treatment 5: 100,000 ppm (S)-methoprene

### EXAMPLE 2

### In Vitro Efficacy of (S)-Methoprene Against Immature Stages and Adult Female Stage of a Colonized Strain of the Cattle Tick Boophilus microplus

Engorged female ticks were separated into groups of 10, weighed and placed in small containers. Group assignments were adjusted so that the total weight of ticks in each group was similar. Each container of 10 ticks was then randomly assigned to one of the five treatment groups, with two replicates per group. Each replicate of ten female ticks each was then immersed in a solution of (S)-methoprene at a concentration of 0, 100, 1000, 10000 and 100000 ppm of (S)-methoprene diluted in acetone:water (40:60 vN). The ticks were maintained immersed in a treatment for 2 minutes.

After exposure, ticks were removed and dried in a pad prepared with paper towels. Each group was then placed into a clean container identified with the treatment group and incubated for 2 weeks at approximately 27° Celsius and 60% or higher relative humidity to determine the proportion of egg laying females. Eggs laid were weighed and incubated for another 4-week period for hatching observation. The results are shown in Tables 1 and 2.

Eggs were laid in all treatment groups but did not hatch in concentrations of 10,000 ppm of (S)-methoprene and above. The dose required to obtain a reduction of 50% of viable eggs compared to the observed response in the control group was between 100 and 1,000 ppm of (S)-methoprene. There was a clear dose-response on the egg viability, which was completely inhibited at concentrations of methoprene at and above 10,000 ppm.

Table 3 illustrates the results of in vivo immersion of female
Boophilus microplus ticks in increasing concentrations of (S)-methoprene.

| | | Number of Ticks | | | | |
|---|---|---|---|---|---|---|
| S-Methoprene | | | Laying | Eggs | | |
| Concentation | Rep- | Treated | Eggs | Weight | Hatch | Viable |
| (ppm) | licate | (Day 0) | (Day 14) | (g) | (%) | (g) |
| 0 | A | 10 | 10 | 1.86 | 100 | 1.86 |
| 0 | B | 10 | 10 | 1.64 | 100 | 1.64 |
| 100 | A | 10 | 9 | 1.38 | 100 | 1.38 |
| 100 | B | 10 | 7 | 1.39 | 100 | 1.39 |
| 1,000 | A | 10 | 3 | 0.47 | 20 | 0.09 |
| 1,000 | B | 10 | 3 | 0.44 | 10 | 0.04 |
| 10,000 | A | 10 | 9 | 1.22 | 0 | 0 |
| 10,000 | B | 10 | 7 | 0.92 | 0 | 0 |
| 100,000 | A | 10 | 4 | 0.58 | 0 | 0 |
| 100,000 | B | 10 | 4 | 0.42 | 0 | 0 |

Table 4 illustrates the Percent Reductions of Boophilus microplus tick's Egg Mass and Viable Egg Mass.

| S-Methoprene | Total Number | Percent Reduction | | | Egg Mass | Percent Reduction |
|---|---|---|---|---|---|---|
| Concentration | of Ticks | in Number of Ticks | Total Egg | Percent Reduction | per Tick | in Egg Mass per |
| (ppm) | Laying Eggs | Laying Eggs | Mass (g) | in Total Egg Mass | (g) | Tick |
| 0 | 20 | | 3.50 | | 0.175 | |
| 100 | 16 | 20% | 2.77 | 21% | 0.173 | 1% |
| 1,000 | 6 | 70% | 0.91 | 74% | 0.152 | 13% |
| 10,000 | 16 | 20% | 2.14 | 39% | 0.134 | 23% |
| 100,000 | 8 | 60% | 1.00 | 71% | 0.125 | 29% |

| S-Methoprene | Total Number | | Percent Reduction | Viable Egg | Percent Reduction |
|---|---|---|---|---|---|
| Concentration | of Ticks | Total Viable | in Viable Egg | Mass per | in Viable Egg |
| (ppm) | Laying Eggs | Egg Mass (g) | Mass | Tick (g) | Mass per Tick |
| 0 | 20 | 3.50 | | 0.175 | |
| 100 | 16 | 2.77 | 21% | 0.173 | 1% |
| 1,000 | 6 | 0.13 | 96% | 0.022 | 87% |
| 10,000 | 16 | 0 | 100% | 0 | 100% |
| 100,000 | 8 | 0 | 100% | 0 | 100% |

What is claimed is:

1. A formulation for preventing oviposition and arresting the development of an arthropod ectoparasite, the formulation comprising:
a) an amount of at least one insect growth regulator effective in arresting the development of an ectoparasite on an animal;
b) a pharmaceutically acceptable liquid carrier or vehicle;
c) optionally a crystallization inhibitor.

2. The formulation according to claim 1, wherein the formulation consists essentially of:
a) an amount of an insect growth regulator effective in preventing oviposition and arresting the development of an ectoparasite on an animal or in the environment;
b) a pharmaceutically acceptable liquid carrier or vehicle;
c) optionally a crystallization inhibitor.

3. The formulation according to claim 1, wherein the formulation further comprises a cosolvent.

4. The formulation according to claim 1, wherein the insect growth regulator effective in inhibiting oviposition and the maturation of an ectoparasite on an animal or in the environment is selected from the group consisting of a methoprene, pyriproxyfen, lufenuron, azadirachtin, diofenolan, fenoxycarb, hydroprene, kinoprene, tetrahydroazadirachtin, and 4-chloro-2-(2-chloro-2-methylpropyl)-5-(6-iodo-3-pyridylmethoxy)pyridizin-3(2H)-one.

5. The formulation according to claim 1, wherein the insect growth regulator is S-methoprene.

6. The formulation according to claim 5, further comprising at least one other insect growth regulator selected from the group consisting of a methoprene, pyriproxyfen, lufenuron, azadirachtin, diofenolan, fenoxycarb, hydroprene, kinoprene, tetrahydroazadirachtin, and 4-chloro-2-(2-chloro-2-methylpropyl)-5-(6-iodo-3-pyridylmethoxy)pyridizin-3(2H)-one.

7. The formulation according to claim 1, wherein the ectoparasite is a tick.

8. The formulation according to claim 7, wherein the tick is a Rhipicephalus spp., a Dermacentor spp., an Amblyomma spp., an Ixodes spp, a Haemaphysalis spp. or a Boophilus spp.

9. The formulation according to claim 8 wherein the tick is selected from the group consisting of Rhipicephalus sanguineus, Dermacentor variabilis, D. reticulatus, Amblyomma americanum, A. hebreum, A. cajennense, Ixodes scapularis, I. ricinus, I. dammini, and Boophilus microplus.

10. A method for preventing oviposition and arresting the development of immature stages of an ectoparasite on an animal host which comprises applying or administering a topical formulation to the host, wherein the formulation is made according to claim 1.

11. The method according to claim 10, wherein the formulation consists essentially of:
a) an amount of an insect growth regulator effective in inhibiting oviposition and the maturation of an ectoparasite on an animal;
b) a pharmaceutically acceptable liquid carrier or vehicle;
c) optionally a crystallizing inhibitor.

12. The method according to claim 10, wherein the ectoparasite is a tick.

13. The method according to claim 12, wherein the tick is a Rhipicephalus spp., a Dermacentor spp., an Amblyomma spp., an Ixodes spp, a Haemaphysalis spp. or a Boophilus spp.

13. The method according to claim 12, wherein the tick is selected from the group consisting of Rhipicephalus sanguineus, Dermacentor variabilis, D. reticulatus, Amblyomma americanum, A. hebreum, A. cajennense, Ixodes scapularis, I. ricinus, I. dammini, and Boophilus microplus.

14. The method according to claim 10, wherein the insect growth regulator effective in inhibiting the maturation of an ectoparasite on an animal is selected from the group consisting of a methoprene, pyriproxyfen, lufenuron, azadirachtin, diofenolan, fenoxycarb, hydroprene, kinoprene, tetrahydroazadirachtin, and 4-chloro-2-(2-chloro-2-methylpropyl)-5-(6-iodo-3-pyridylmethoxy)pyridizin-3(2H)-one.

15. The formulation according to claim 10, wherein the insect growth regulator is S-methoprene.

16. The formulation according to claim 15, further comprising at least one other insect growth regulator selected from the group consisting of a methoprene, pyriproxyfen, lufenuron, azadirachtin, diofenolan, fenoxycarb, hydroprene, kinoprene, tetrahydroazadirachtin, and 4-chloro-2-(2-chloro-2-methylpropyl)-5-(6-iodo-3-pyridylmethoxy)pyridizin-3(2 H)-one.

17. The method of claim 10, wherein the pharmaceutically acceptable liquid carrier is selected from the group consisting of acetone, acetonitrile, benzyl alcohol, butyl diglycol, dimethylacetamide, dimethylformamide, dipropylene glycol n-butyl ether, ethanol, isopropanol, methanol, ethylene glycol monoethyl ether, ethylene glycol monomethyl ether, monomethylacetamide, dipropylene glycol monomethyl ether, liquid polyoxyethylene glycols, propylene glycol, 2-pyrrolidone, diethylene glycol monoethyl ether, ethylene glycol, and diethyl phthalate fatty acid esters.

18. The method according to claim 10, wherein the optional crystallization inhibitor is selected from the group consisting of an anionic surfactant, a cationic surfactant, a non-ionic surfactant, an amine salt, an amphoteric surfactant or polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters, lecithin, sodium carboxymethylcellulose, and acrylic derivatives, or a mixture of these crystallization inhibitors.

19. The method of claim 15, wherein the concentration of the (S)-methoprene is from about 5% w/v to about 25% w/v.

20. The method of claim 10, wherein the concentration of IGR in the formulation is from about 5% w/v to about 25% w/v.

21. The method of claim 10, wherein the pharmaceutically or veterinary acceptable film agent selected from the group consisting of a polyvinylpyrrolidone, a polyvinyl alcohol, a copolymer of vinyl acetate, a copolymer of vinyl pyrrolidone, a copolyvidone and mixtures thereof.

22. The method according to claim 10, wherein the topical formulation is a spot-on formulation.

23. The method according to claim 10, wherein the topical formulation is a spray.

24. The method according to claim 10, wherein the host animal is a mammal or a bird.

25. The method according to claim 24, wherein the mammal is a cow, a sheep, a horse, a pig, a cat or a dog.

26. The method according to claim 10, wherein the topical formulation is applied to the host as a powder, a shampoo, a soap, or a wash.

27. The method according to claim 10, wherein the transmission of an arachnid ectoparasite from a first host to a second host is interrupted by preventing the development of an immature stage of the arachnid on or from the first host into a transmissible mature stage which comprises applying or administering the formulation to said first host.
